(19) United States
(12) Patent Application Publication
(10) Pub. No.: US 2017/0185485 A1
(43) Pub. Date: Jun. 29, 2017

(54) METHOD AND SYSTEM FOR CLOUD PARALLELIZATION OF RECURSIVE LIFING CALCULATIONS

(71) Applicant: General Electric Company, Schenectady, NY (US)

(72) Inventors: Paul Edward Cuddihy, Ballston Lake, NY (US); Gerald Bowden Wise, Niskayuna, NY (US)

(21) Appl. No.: 14/982,901

(22) Filed: Dec. 29, 2015

(51) Int. Cl. G06F 11/14; G06F 11/30; G06N 7/00; G06F 11/34

(52) U.S. Cl. CPC G06F 11/142; G06F 11/3409; G06F 11/3024; G06N 7/005; G06F 2201/805

(57) ABSTRACT

A system and method include receiving data elements associated with optimizing a work scope associated with a repair to a first component of a plurality of components of a piece of equipment associated with a system; assigning each component to a group; creating at least one sub-group for each group, wherein each sub-group is a first level sub-group; and recursively generating at least one additional sub-group for each sub-group until a recursion stop point is achieved, wherein each additional sub-group is a second level sub-group and without calculating a life-cycle cost for a path from the group to a last sub-group generated at the recursion stop point. Numerous other aspects are provided.

### FIELD

One or more embodiments described below relate to the electrical, electronic and computer arts, and more particularly, to cloud parallelization of recursive lifing calculations and the like.

### BACKGROUND

A Competing Life Distribution Model is a technique used for modeling complex system behavior for reliability. In this process, the complex system is viewed as a set of components (i.e., parts, modules, compartments, etc.), each having a defined life distribution model (e.g., Weibull, lognormal, etc.), which acts independently of the others to drive the system to failure.

Conventional methodology for determining the time to failure of the system is to simulate random variables for each component and to choose the minimum failure time of a component as the failure time of the system. Once the failure takes place, a work scope activity is performed as part of the simulation process. The work scope may represent a repair of the failing component and perhaps other components (depending on the defined work scope) in a single shop visit, including a resetting of the time to failure clock of those components that have been repaired. The simulation then continues to determine the time to the next failure, etc.

“Work scope optimization” is the problem of deciding what set of repairs will produce the optimal outcome over the life of a system. For each possible failure, the optimal (e.g., lowest cost, profit, revenue, or operating margin) repair is calculated. Calculations may involve the recursive application of the process to the new system state after each possible failure. Each calculation may include hundreds or even thousands of recursive sub-calculations over the life of a single system. As used herein, a recursive calculation is a calculation that calls itself with smaller instances (or a subset of) input values and obtains the result for the current input by applying operations to the returned value for the smaller instances.

While standard cloud hardware and scheduling systems are able to perform quick execution of calculations, because the time and memory requirements for a recursive calculation are not known or cannot be easily estimated, a standard cloud scheduler cannot make a good guess for how much compute time or memory is needed and therefore how many compute nodes are needed. Standard cloud schedulers receive a job or task and then analyze the job to determine the space needed in the cloud (e.g., processor) to perform the job. As described above, with a recursive calculation, the calculation is repeated multiple times, and the end point is not known before the calculation begins. If, for example, a standard cloud infrastructure (e.g., a scheduler) was tasked with performing a recursive calculation (essentially having a job launch more jobs, where each job is a calculation), the cloud (e.g., processor) may “lock up” when there are not enough free slots to complete recursive calculations, which results in higher-levels of the recursive process being stuck waiting.

Systems and methods are desired which optimize the use of a recursive calculation using standard cloud infrastructure.

### SUMMARY

In accordance with an embodiment of the invention, a method is provided. The method includes receiving data elements associated with optimizing a work scope associated with a repair to a first component of a plurality of components of a piece of equipment associated with a system; assigning each component to a group; creating at least one sub-group for each group, wherein each sub-group is a first level sub-group; and recursively generating at least one additional sub-group for each sub-group until a recursion stop point is achieved, wherein each additional sub-group is a second level sub-group and without calculating a life-cycle cost for a path from the group to a last sub-group generated at the recursion stop point.

In accordance with another embodiment of the invention, a system is provided. The system includes at least one piece of equipment including a plurality of components; a structure module operative to: receive data elements associated with optimizing a work scope to repair a first component of the plurality of components of the piece of equipment; assign each component to a group; create at least one sub-group for each group, wherein each sub-group is a first level sub-group; and recursively generate at least one additional sub-group for each sub-group until a recursion stop point is achieved, wherein each additional sub-group is a second level group, without calculating a life-cycle cost for a path from the group to a last sub-group generated at the recursion stop point.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of elements for carrying out one or more of the method steps described herein; the elements can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Other features and aspects of the present invention will become more fully apparent from the following detailed description, the appended claims and the accompanying drawings.

### BRIEF DESCRIPTION OF THE DRAWINGS

The construction and usage of embodiments will become readily apparent from consideration of the following specification as illustrated in the accompanying drawings, in which like reference numerals designate like parts, and wherein:

FIG. 1 illustrates a chart according to some embodiments;

FIG. 2 is a flow diagram of a process according to some embodiments of the present invention;

FIG. 3 illustrates a block diagram of system architecture according to some embodiments; and

FIG. 4 illustrates a block diagram of a system according to some embodiments.

### DETAILED DESCRIPTION

Conventional methodology for determining the time to failure of the system is to simulate random variables for each component and to choose the minimum time to failure for a component as the failure time for the system. Once the failure takes place, a work scope activity is performed as part of the simulation process. The work scope may represent a repair of the failing component and perhaps other components (depending on the defined work scope) in a single shop visit, including a resetting of the time to failure clock of those components that have been repaired. The simulation then continues to determine the time to the next failure, etc.

“Work scope optimization” is the problem of deciding what set of repairs will produce the optimal outcome over the life of a system. For each possible failure, the optimal (e.g., lowest cost, profit, revenue or operating margin) repair is calculated. The optimal work scope may be determined by calculating the minimum (or maximum) of cost, profit, revenue, or operating margin percent. Lowest cost or maximum operating margin may be common strategies. For work scope optimization, the optimization criteria may be to maximize operating margin. Operating margin may be a margin ratio used to measure a company's pricing strategy and operating efficiency. Operating margin may be a measurement of what proportion of a company's revenue is left over after paying for variable costs of product such as wages, raw materials, etc. Calculations may involve the recursive application of the process to the new system state after each possible failure. Each calculation may include hundreds or even thousands of recursive sub-calculations over the life of a single system. As used herein, a recursive calculation is a calculation that calls itself with smaller (or simpler) input values and obtains the result for the current input by applying simple operations to the returned value for the smaller input.

While standard cloud infrastructure (e.g., hardware and scheduling systems) are able to perform quick execution of calculations, standard cloud schedulers do not support recursive calculations. Standard cloud schedulers receive a job or task and then analyze the job to determine the space needed in the cloud (e.g., processor) to perform the job. As described above, with a recursive calculation, the calculation is repeated multiple times, and the end point is not known before the calculation begins. If, for example, a standard cloud scheduler was tasked with performing a recursive calculation (essentially having a job launch more jobs, where each job is a calculation), the cloud (e.g., processor) may “lock up” when there are not enough free slots to complete recursive calculations, which may result in higher-levels of the recursive process being stuck waiting. It also may be undesirable to use high-cost “high performance computing” infrastructures or a “custom scheduler” to perform recursive calculations, as they may be expensive and not readily available.

Accordingly, a method and system are provided to allow recursive calculations to be performed in a cloud using a standard non-recursive job scheduler. For lifing calculations, this may be accomplished by building a tree recursively in one initial step, and then using the cloud to calculate the costs at each node in the tree, and finally by rolling up those costs in a single (post-cloud) step. In particular, in one or more embodiments, a method and system are provided to execute a recursive calculation on a standard (e.g., non-recursive) cloud scheduler, by transforming a recursive work scope optimization calculation into non-recursive sub-tasks which are more amenable to execution by standard cloud processors, and which may be executed in parallel fashion by a standard cloud processor, or on a single multi-threaded machine. The recursion may be divided into three parts: first, executing the recursion until the problem is broken up into a suitable number of parallel pieces in a tree, second, completing the recursion of those pieces in a single thread or on a single node in the cloud, and third, rolling up the results through the “tree”. Embodiments provide the process and data structures which enable a recursive calculation to be started, and continued until a reasonably optimal number of sub-pieces have been generated. The sub-pieces may be run in a cloud using standard non-recursive scheduling processes, and then the pieces are re-assembled and the recursion completes.

In one or more embodiments, the work scope optimization calculation may be broken up into a set of objects (e.g., ConditionCost and TimeCost) responsible for performing the calculation of its sub-part. Each sub-calculation may also have an associated set of sub-calculations, in the form of nestablelists, which may be calculated recursively to produce the answer. One or more embodiments provide for the conditions and parameters needed for the sub-calculations to be setup using a data structure and then returned to a caller without actually invoking the recursive calculation. This may allow the underlying sub-calculations to be parallelized. The sub-calculations may be executed by cloud processors via a Map reduce method, which may use a file system to distribute files and inputs to a calculation and then use the same file system to store the results of the sub-calculations so that these results may be later rolled up to provide the overall result. To facilitate the storage of these inputs and outputs, objects may be stored in files using keys that store information about an object's position in a list. In some embodiments, this storage may be executed by application of a static method referred to as createSerializeFilename (String base, String key), which may work in tandem with an extractKeyFromFileName( ) method. A manager object may be used to help list construction and deconstruction via generateSubCostList( ) and putCookedSubcosts( ) methods.

For example, a recursive calculation may be used to compute expected failures and costs for an aircraft engine, wherein the engine is a system viewed as consisting of N components. These lifing calculations may be performed with Weibull curves to model failure probabilities. For each possible failure, the optimal repair is calculated, where “optimal” corresponds to lowest cost. The lifing calculation is recursively applied to the new engine state after each possible failure. Each iteration of the recursive calculation may have the following steps:
1. The times to failure for each of the components may be simulated: t₁, t₂, . . . t_{N}.
2. Then the minimum of these times may be determined. If component m has the minimum time, then the time to the first failure for the system is T_{f}=tₘ
3. The defined work scope may be used to determine which components get repaired. For example, the work scope rules may state that when component m fails, component m along with components r and q get repaired.
4. New times to failure for components m, r, and q are simulated. These new simulated values may be added to the current time T_{f} to obtain new values t_{m, t}r, and t_{q}.
5. Repeat step 2 to find the next time to failure.
6. Continue until a desired recursive stop point is reached.

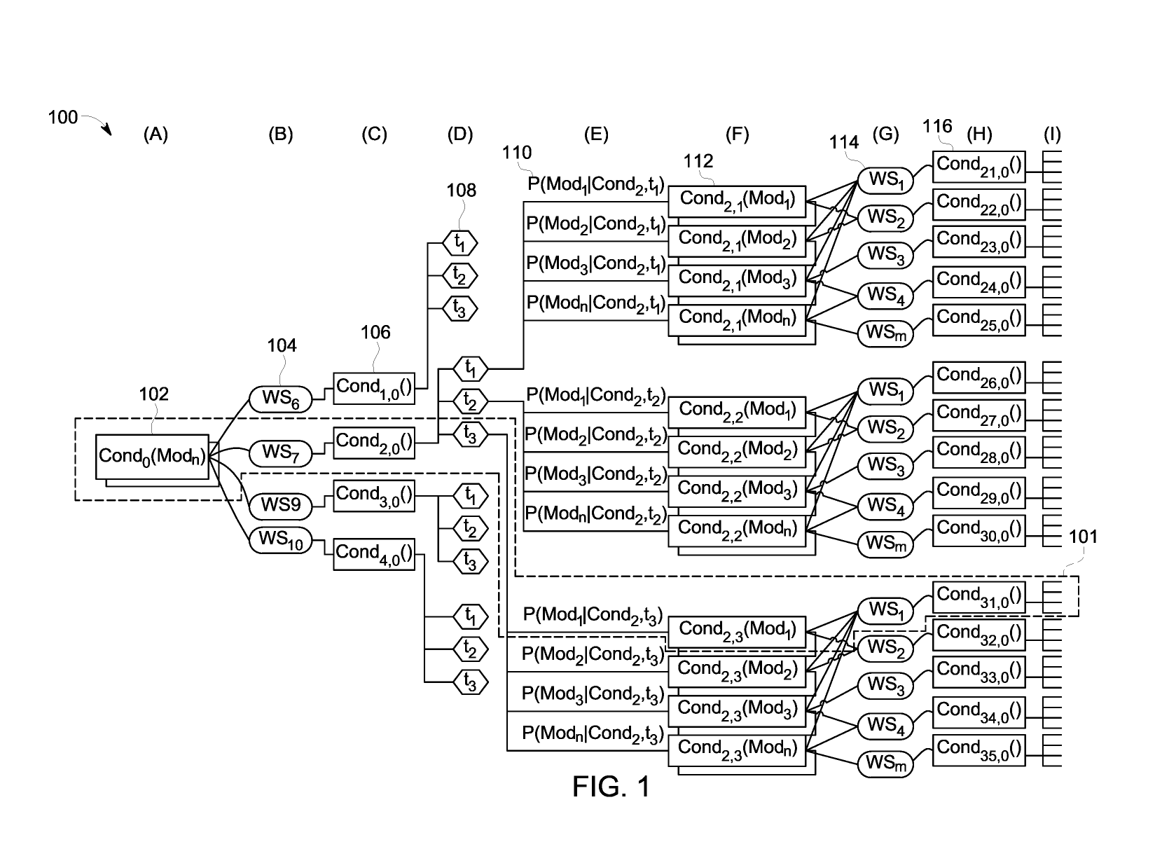

Embodiments of the invention provide for the generation of a tree (FIG. 1), where a first iteration of the recursive calculation yields a group and then each iteration of the recursive calculation thereafter yields a sub-group extending from each existing sub-group until a recursion stop point is reached. The process of creating the sub-groups is recursion. While a life-cycle cost of replacing or repairing each component for a path from the group to a last sub-group generated at the recursion stop point may be calculated at a future point, the life-cycle cost is not calculated in the generation of the tree. After the tree is generated, in one or more embodiments, the calculation for the life-cycle cost for each sub-group may be executed independently and in parallel, such that, for example, subgroup A does not need to finish to start subgroup B—each of subgroup A and subgroup B is a discrete job that may launch at the same, or substantially the same, time. Based on the calculated life-cycle cost, an optimal work scope may be determined.

The technical effect is that system and part life cost calculations may be performed with standard software and hardware, achieving high performance at low cost and high availability. One of the biggest advantages provided by the embodiments described herein is to expand the utility of the recursive calculation such that it may be used on an entire fleet of engines, as opposed to just a single asset (e.g. a single engine), and in some instances multiple times to test different contract rules, costs, work scopes or part life expectancies. Since single runs may take from a few minutes to hours (depending on the number of work scopes, modules, and depth of recursion (e.g., how many times the recursive calculation is executed), for example), embodiments may reduce execution time of these multiple asset experiments by a factor of 1000× (or however many free nodes are available in a cloud). Further, highly parallel cloud runs of the recursive lifing calculation on an entire fleet may be used to gain new knowledge of how the value of a contract for the fleet is sensitive to each element of the contract, to cost changes, to new information about part life, etc. Embodiments also provide for the separation of the recursive calculation from the parallelization, such that the same code may be used without modification to run a single work scope optimization and fleet work scope optimization quickly.

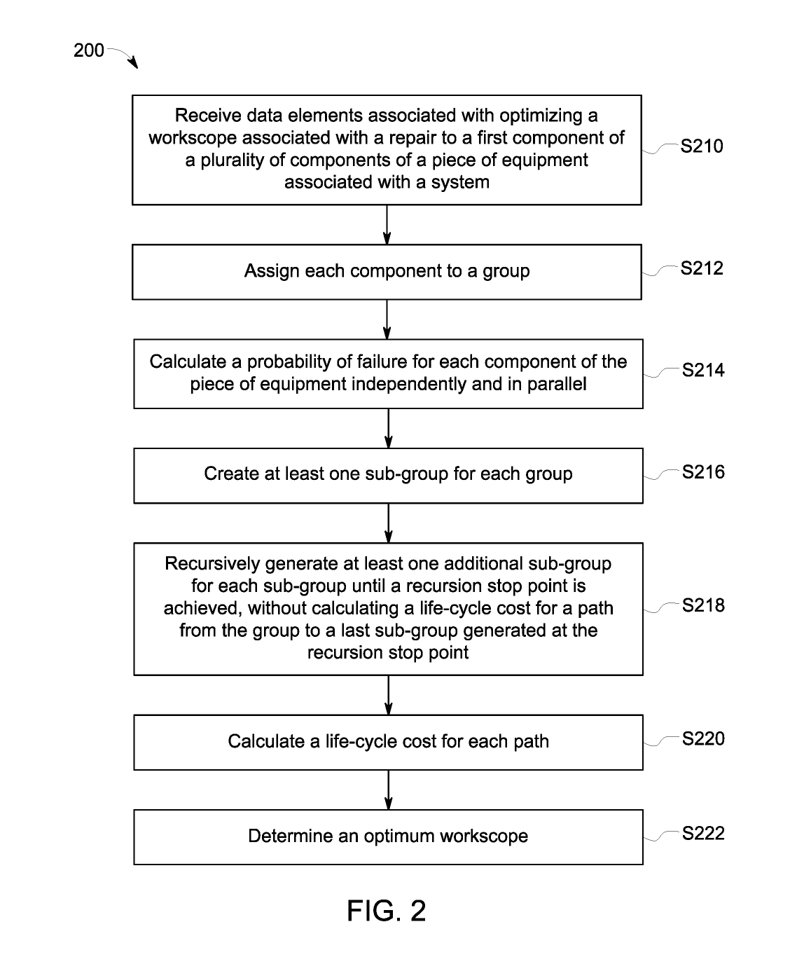

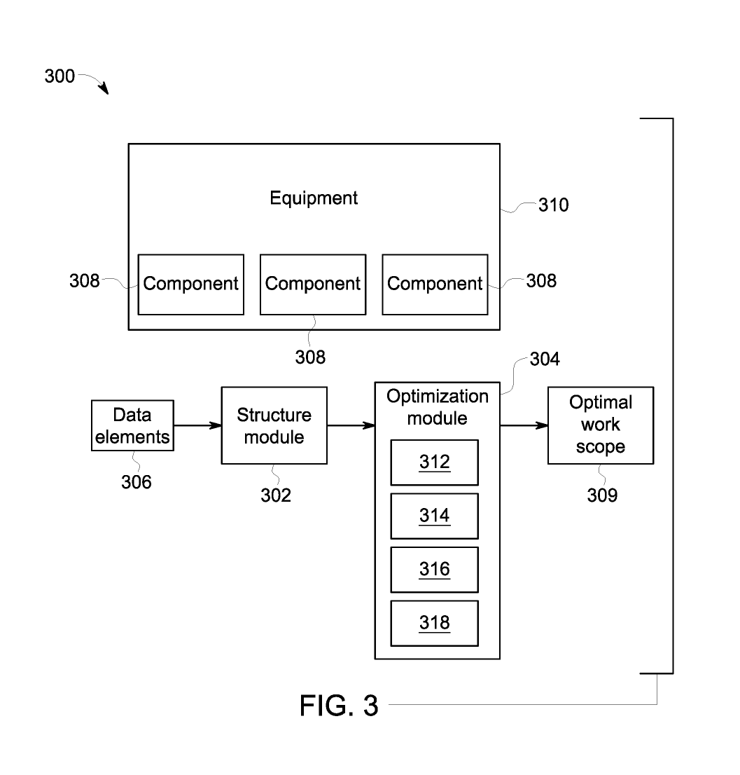

Turning to FIGS. 1-3, a simplified functional overview of the work scope optimization tree 100 (FIG. 1) and a method 200 (FIG. 2) that might be performed by all or some of the elements of the system 300 (FIG. 3) to generate the tree 100 according to some embodiments is provided. As used herein, the generic term “cost” may represent the economic implications of the condition of the equipment, and “engine” represents that equipment. However, embodiments apply to any type of equipment that may be modelled with Weibull distributions may be used to optimize different types of cost, margins, and/or value calculations.

The flow chart(s) described herein do not imply a fixed order to the steps, and embodiments of the present invention may be practiced in any order that is practicable. Note that any of the methods described herein may be performed using any suitable combination of hardware (e.g., circuit(s)), software or manual means. For example, a non-transitory computer-readable storage medium (e.g., a fixed disk, a floppy disk, a CD, a DVD, a Flash drive, or a magnetic tape) may store thereon instructions that when executed by a machine result in performance according to any of the embodiments described herein. In one or more embodiments, the components of the system 300 (e.g., the structure module 302, and the optimization module 304) may be necessarily rooted in computer technology and may be conditioned to perform the process 200, such that the components and system 300 are special purpose elements configured to perform operations not performable by a general purpose computer or device. Examples of these processes will be described below with respect to the elements of the computing device, but embodiments are not limited thereto.

In the example shown herein, the equipment starts at Column (A) in the initial condition Cond₀ 102. A condition consists of a list of sub-modules or components and the amount of life or wear each has accumulated. In the example shown in FIG. 1, the condition of the engine is augmented with the name of a module, Modₙ, which has been identified as being in need of repair or replacement. The module may include one or more components in need of repair or replacement. While a module may include more than one component for repair or replacement, as used herein, “module” and “component” may be used interchangeably, unless otherwise indicated.

At S210, data elements 306 associated with optimizing a work scope are received. In one or more embodiments, data elements 306 (inputs) to the work scope optimization process may include equipment or engine condition, including a definition of included modules (and time since last repair), what limited life parts (LLP) are contained on the equipment and how many cycles remain until a repair is needed (e.g., statistical curves may be used to determine how long parts may last), a set of work scope alternatives for each module, and a definition of Weibull curves (one definition per module). Each of these items included in the data elements 306 may be received from different sources. In one or more embodiments, Weibull curves may be statistical curves built from past failures. Other suitable curves describing time-to-failure may be used. The data elements 306 may be associated with a repair to a first component 308 of a plurality of components of a piece of equipment 310 associated with a system.

Then at S212, each component 308 is assigned to a group or work scope alternative, corresponding to a failure of the component 308. As described above, and as used herein, a work scope is a combination of repairs or replacements which may be performed in a single shop visit. Each work scope may involve the replacement or repair of additional components or modules. Column (B) includes one or more work scopes 104 that each involve repairs to Modₙ. After the work scope 104 (e.g., repair or replacement) is performed, the engine will have a new condition 106, shown in Column (C). Although the new condition 106 is derived from Cond₀, it receives a new condition label such as Cond_{1,0}( ). This label indicates a new engine condition, 1, at time=0, and with no module in need of repair ( ). In one or more embodiments, each engine condition in Column (C) is an independent calculation that may be executed in parallel fashion on at least one of multiple threads or different nodes of a cloud. In one or more embodiments, the information at Column (C) is information about each possible work scope 104 at a top level of the optimization.

In one or more embodiments, the cost of a new engine condition such as Cond_{1,0}( ) is predicted by choosing a number of integration points or times in the future. These future times 108 are represented in the tree diagram 100 in Column (D) as t₁, t₂, and t₃. In one or more embodiments, the number of integration points or times 108 in the future may be user-defined.

Then in S214, a probability of failure 110 for each component of the piece of equipment at a given future time is calculated. The probability (P) of failure 110 of the components 308 in the module at future time 108 is shown in Column (E). In one or more embodiments, the failure probability 110 may be modeled with Weibull distributions. Other suitable distributions may be used to model the failure probability (e.g., other parametric statistical curves (typically exponential curves) or non-parametric failure data (e.g., histograms of time on X and number of failures on Y).

In terms of generating the tree 100, each condition 106 shown in Column (C) may be referred to herein as “a group”, and in S216, at least one sub-group is created for each group, where each sub-group is a first level sub-group. In one or more embodiments, the first level sub-group may be a new condition (i.e., with the failed module) 112 shown in Column (F). In one or more embodiments, the cost of an engine in a given condition at a given time may be estimated by computing the probability (P) that each module will have failed at that given time 110, shown in Column (E), and multiplied by the cost of an engine in that new condition (i.e., with the failed module) 112, where the new condition is shown in column (F).

The cost of the engine in the new condition 112, Column (F) is calculated by finding a work scope 114, shown in Column (G), which applies to the failed module and for an optimal work scope, one that also has the lowest cost, in one or more embodiments. Then in S218, at least one additional sub-group is recursively generated for each sub-group until a recursion stop point is achieved, where the additional sub-group may be a new condition 116 shown in Column (H). The recursive calculation may be repeated until a recursion stop point is encountered. In one or more embodiments the recursion stop point may be user-defined. For example, engines may be run to a given number of shop visits, until the probability of future shop visits is less than p, or until the probability of a given subset of failures is less than p. Other statistical cutoffs may also be used to determine the recursion stop point. In one or more embodiments, the recursion stop point may be implemented with conditionals at various stages of recursion, such as at Column (E) and Column (H).

In one or more embodiments, the recursive calculation is executed without calculating a life-cycle cost for a path 101 from the initial condition (e.g., Column (A), through a group (e.g., Column (C)) to a last sub-group generated at the recursion stop point. After the tree 100 is generated, in S220, a life-cycle cost for each path 101 is calculated. Life cycle costs may be the total cost of ownership. For example, it may be the costs of repairs over the life of the equipment. In one or more embodiments, the value of the equipment at the end of the contract may be figured into the life-cycle costs. In one or more embodiments, the life-cycle cost of the path 101 is the sum of costs of the work scopes at Column (B) and Column (G). Calculating the costs of the new conditions 116 shown in Column (H) is a recursive calculation, as represented in Column (I).

The inventors note that it may be more desirable to perform a recursive calculation between Column (F) and Column (G), as compared to Column (A) and/or (F), as efficiency may be gained between columns (F) and (G) when the optimum (e.g., least expensive) work scope may be computed for each possible module failure. When a single work scope applies to multiple modules, it may result in the same engine condition in Column (H) regardless of which module was initially indicated as needing repair. For example, WS₂ in Column (G) is the single work scope that applies to both Mod₁ and Mod₂ in Column (F). As such, the work scopes and conditions in Columns (G) and (H) may be computed only once and the results shared between all applicable modules in Column (F). At S222, an optimal work scope 309 may be determined by the optimization module 304. In one or more embodiments, the optimum work scope is a cost function. In one or more embodiments, the optimum work scope may be determined as the work scope most likely to lead to the lowest total life cycle cost. However, other options for optimization may include, but are not limited to, profit, revenue and operating margin. Optimization criteria associated with work scope optimization may be to maximize operating margin.

The inventors note that other aspects related to a system may affect the choice of a work scope. For example, in the aviation domain, one aspect is life limited parts (LLP's). These LLPs may be removed at a certain life, even though failure has not occurred. Additionally, some contracts may specify that a repaired engine must not have any LLPs with fewer than N cycles remaining on them. Logic associated with these aspects may be inserted between Columns (A) and (B) and between Columns (F) and (G) without fundamentally changing the architecture.

Turning to FIG. 3, the system 300 for parallelization and recursive calculations is provided according to one or more embodiments. As used herein, parallelization refers to parallel computing which is a type of computation where many calculations are carried out simultaneously. One or more embodiments may use existing/generic cloud computing environments (e.g., HADOOP™) for parallelization.

The system 300 may include the structure module 302 and the optimization module 304. Generally, in one or more embodiments, the structure module 302 may generate the tree 100 (FIG. 1) or other suitable structure or architecture used in the application of the recursive calculations. In one or more embodiments, the structure module 302 may receive one or more data elements 306 associated with a repair or replacement to a plurality of components 308 of the piece of equipment 310 to generate the tree 100, without calculating a life-cycle cost for any paths 101 of the tree 100. In one or more embodiments, the optimization module 304 may receive the structure generated by the structure module 302 and may calculate a probability of failure for each component of the piece of equipment independently and in parallel; calculate a cost of replacing or repairing each component for each path 101, wherein each calculation is performed independently and in parallel; the probability of failure may be multiplied against the calculated cost of replacing or repairing each component for each path, and determine an optimum work scope based on the calculated life-cycle cost, taking into account the failure probability calculation, as described above. For example, after an item is replaced, the probability of failure for that item decreases, and this information may be taken into account when determining an optimum work scope based on life-cycle cost. In one or more embodiments, the probability of failure may be calculated as the computation unfolds through the tree. For a given work scope alternative and module condition at time t, a probability may be calculated based on probability density functions (which may use the Weibull distributions).

In one or more embodiments, prior to determining an optimum work scope, the optimization module 304 may calculate the expected cost of a particular engine condition. In one or more embodiments, the optimization module 304 may include an object responsible for the calculation of the expected cost of the particular engine condition. While herein the object may be referred to as ConditionCost 312, any other suitable object may be used. The ConditionCost object may correspond to Columns (C) and (H) of FIG. 1. In one or more embodiments, the optimization module 304 may also include a TimeCost object 314 responsible for the calculation of the cost of an engine condition at a given time integration point/point in time. In one or more embodiments, the TimeCost calculations contain ConditionCost objects, such that the objects cooperate in a single recursive architecture.

In one or more embodiments, the ConditionCost object 312 may compute cost in two different modes without code duplication. In a first mode, the ConditionCost object 312 may include a calculate( ) method which may recursively compute the expected costs of an engine condition at a particular time. A typical single run may have only a handful of these parallel groups (e.g., Column (C)). In a second mode, to achieve higher parallelization, the ConditionCost object 312 may include a pair of methods: getRawSubcosts( ) and putCookedSubcosts( ). The getRawSubcost( ) method applied to Cond_{2,0}_{_{( )}}, for example, returns all of the ConditionCost sub-objects in Column (H), without performing any further recursion or calculating any actual costs. However when the calculate( ) method of these conditions is called, a fully recursive calculation of their costs is performed. Then these fully computed costs (referred to herein as “cooked” ConditionCosts) may be provided back to Cond_{2,0}_{_{( )}} (e.g., Column (C)) using a putCookedSubcosts(<list>) method, then a last top-level of recursive calculations may be performed and the final result (e.g., expected cost) of Cond_{2,0}_{_{( )}} (Column (C)) is obtained.

In one or more embodiments, to avoid re-coding any calculations for different scenarios (e.g., running serially instead of parallel) the calculate( ) method applied by the optimization module 304 may call list=this.getRawSubcost( ), then call the calculate( ) method on each subcost, and finally call this.putCookedSubcosts(list).

In one or more embodiments, as the recursion stop point may depend on the number of shop visits (which may be equivalent to the depth of the recursion), the calculate( ) method may include a recursion depth level as a parameter, which may be incremented with each level of recursion, and may, in turn, allow for straight-forward coding of recursion break logic.

In one or more embodiments, the optimization module 304 may include an object referred to herein as a NestableList( ) object 316. The NestableList( ) object 316 may address the challenges created by the lists of ConditionCost objects 312 returned from getRawSubcost( ) and passed into putCooked Subcosts( ). In one or more embodiments, the returned lists of sub-costs may have a structure that is not flat. For example, the sub-costs in Column (H) may be ordered by work scope at the lowest level, and then the sub-costs may be grouped by time so they can be rolled up into the correct place at Column (D). To complete the computations in putCookedSubcosts( ), the structure associated with the list is known via the NestableList( ) object 316.

In some embodiments, a feature of the NestableList( ) object 316 may be that the list may behave as an ordered list (similar to an ArrayList). An ordered list may correspond to Cond_{21,0}( ) down through Cond_{25,0}( ) in Column (H), for example. This ordered list of sub ConditionCosts may correspond to a numbered list of work scopes. In some embodiments, such a list may be built and accessed with methods called addRootItem(Integer, V) and getRootItem(Integer), where V is the ConditionCost.

In some embodiments, the NestableList( ) object 316 may also provide for nesting the objects as an arbitrarily deep list of lists. For example, once the sub-costs in Column (H) are added to three distinct NestableLists corresponding to the three times in Column (D), a new NestableList may be created and all the sub-lists added to it using, for example, an addListItem(Integer, NestableList(V)) method. These lists may later be retrieved with a getListItem(Integer) method, for example. A depth( ) method may return the depth of nesting in any list. Of note, the use of NestableList objects may allow for an arbitrarily deep list of sub-costs.

In one or more embodiments, a loop iterator (e.g., hashKeySet( )) may be associated with the NestableList( ) object 316. As used herein, “key” refers to a unique identifier to each node. The loop iterator may iterate through every key in the NestableList object without any guarantee of order. In one or more embodiments, the static (e.g., non-recursive) method getKeyNestLevel(String) may return the nesting depth of the object referred to by a particular key, which may allow an arbitrary NestableList of ConditionCosts to be calculated with a simple “for” loop. The benefit of this is that while the list is built as a recursive tree so it has a tree-like structure, it may also be iterated like a flat list. This flat list may be the list of pieces that is sent off for parallel execution. With a flat list, each piece may be calculated individually without taking into account where it falls in the tree, making for easier, and thereby more efficient, calculations.

In one or more embodiments, the ConditionCost object 312 and NestableList object 316 may be serialized by the optimization module 304. Each ConditionCost object 312 may be serialized (i.e., written out as a stream to a file). These files may be shuffled across the cloud and each node may calculate one of them and re-serializes them this time with the cost calculations. In one or more embodiments, all of the completed (“cooked”) nodes may then be combined into a final answer. Serialization may be important in the execution of the sub-calculations on conventional cloud architectures for organizational purposes, as conventional cloud architectures may use a file system to distribute files and inputs to the process, and then use that same file system to store the results of the sub-calculations so that these results may be later rolled up to provide the overall result. In one or more embodiments, a Map Reduce method may be used to serialize the ConditionCost 312 and NestableList 316.

In one or more embodiments, ConditionCost objects 312 may be made serializable by the optimization module 304 using a standard Serializable interface, where the members (both “raw” and “cooked”) of the object class are of a type (e.g., basic Java) that is easily serializiable (e.g., written to a file). In one or more embodiments, a Map Reduce method may be a process of doing parallel processing. Other suitable ways to execute paralleization may be used (e.g., multiple threads). In one or more embodiments, the Map Reduce method may simply read the “raw” ConditionCost, compute it, and write it back to the file system. In one or more embodiments, the Map Reduce method may store and retain all intermediate information about sub-costs and times until the end of the calculation.

In one or more embodiments, NestableList objects 316 may be serialized by the optimization module 304 in a way that allow the lists to be deconstructed, contents serialized, then reconstructed. This type of serialization may allow maximum flexibility in parallelization technique over arbitrarily structured NestableLists. To facilitate the storage of the inputs and outputs, NestableList objects 316 may be stored in files using keys that store information about an object's position in a list. In some embodiments, this storage may be executed by application of a static method referred to as createSerializeFilename(String base, String key), which may build a file name from a base and a NestableList key. Storage may be executed by application of any other suitable method. The filename may contain information about the object's position in the structure of the list. In one or more embodiments, the position information stored via the key may take the form of a simple string, such as “1-2-6,” which may indicate that the list has a depth of three and the object referenced by this key resides in the first position of the top level, the second position of the next level, and the sixth position in the last level.

In one or more embodiments, the createSerializeFilename( ) method may work in tandem with extractKeyFromFilename(String base, String filename) and addHashedItem(String key, V item) as follows: if all members of a list are stored in files named with their “serialize filenames,” they may be read in, and their keys extracted by, extractKeyFromFilename( ). If each member is then added to the new NestableList using addHashedItem( ), the resulting list may have the same contents as the original had before original members were serialized to disk. As such, through the keys encoded in the file names, the structure of the NestableList may be serialized.

In one or more embodiments, the optimization module 304 may also include a ConditionCostManager object 318 to help list construction and de-construction tasks. A generateSubcstsList( ) method associated with the ConditionCostManager 318 may provide a generalized list-building function that may create a new NestableList of all of the sub-cost objects regardless of the structure of a NestableList of ConditionCost objects, resulting in two extra layers of depth. After the sub-costs are calculated, the ConditionCostManager 318 may use a putCookedSubcosts( ) method, associated therewith, to complete the cost calculation of the cond_list. Other suitable methods may be used to complete the cost calculation.

In one or more embodiments, the ConditionCostManager 318 may also use a generate WorkscopeConditions(EngineCondition c, ArrayList<Workscope>) method to return a one-dimensional NestableList of ConditionCost objects representing the engine condition c with each of the supplied work scopes applied to it.

As described above, the transformed non-recursive sub-tasks may be executed in parallel fashion on a single multi-threaded machine, instead of on a cloud processor. In one or more embodiments, to execute on a multi-threaded machine, the optimization module 304 may include logic for executing the calculate( ) method on multiple threads.

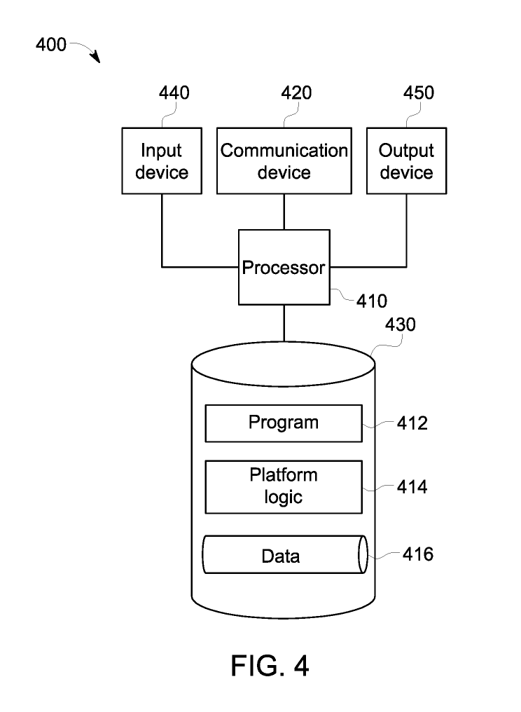

Note that the embodiments described herein may be implemented using any number of different hardware configurations. For example, FIG. 4 illustrates a Recursive Work scope Optimization Platform 400 that may be, for example, associated with the system 300 of FIG. 3. The Recursive Work scope Optimization Platform 400 comprises an optimization processor 410, such as one or more commercially available Central Processing Units (CPUs) in the form of one-chip microprocessors, coupled to a communication device 420 configured to communicate via a communication network (not shown in FIG. 4). The communication device 420 may be used to communicate, for example, with one or more users or computers. The Recursive Work scope Optimization Platform 400 further includes an input device 440 (e.g., a computer mouse and/or keyboard to enter information about transactions) and an output device 450 (e.g., a computer monitor or printer to output a transaction information report and/or evaluation).

The processor 410 also communicates with a storage device/memory 430. The storage device 430 may comprise any appropriate information storage device, including combinations of magnetic storage devices (e.g., a hard disk drive), optical storage devices, mobile telephones, and/or semiconductor memory devices. The storage device 430 stores a program 412 and/or optimization platform logic 414 for controlling the processor 410. The processor 410 performs instructions of the programs 412, 414, and thereby operates in accordance with any of the embodiments described herein. For example, the processor 410 may receive input data which may then be analyzed by the processor 410 to automatically determine an optimal work scope. The storage device 430 may also store data 416 in a database, for example.

The process steps (e.g., programs 412, 414) stored in the storage device 430 may be read from one or more of a computer-readable medium, such as a floppy disk, a CD-ROM, a DVD-ROM, a Zip™ disk, a magnetic tape, or a signal encoding the process steps, and then stored in the storage device 430 in a compressed, uncompiled, and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software. The programs 412, 414 may furthermore include other program elements, such as an operating system, a database management system, and/or device drivers used by the processor 410 to interface with peripheral devices.

As used herein, information may be “received” or “retrieved” by or “transmitted” to, for example: (i) the Recursive Work scope Optimization Platform 400 from another device; or (ii) a software application or module within the Recursive Work scope Optimization Platform 400 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a monitoring module, a learning and prognostics module, an optimization module, and an adaptive supervisor module. The method steps can then be carried out using the distinct software modules and/or sub-modules of the system, as described above, executing on one or more hardware processors 410 (FIG. 4). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A method comprising:
receiving data elements associated with optimizing a work scope associated with a repair to a first component of a plurality of components of a piece of equipment associated with a system;
assigning each component to a group;
creating at least one sub-group for each group, wherein each sub-group is a first level sub-group; and
recursively generating at least one additional sub-group for each sub-group until a recursion stop point is achieved, wherein each additional sub-group is a second level sub-group and without calculating a life-cycle cost for a path from the group to a last sub-group generated at the recursion stop point.

2. The method of claim 1, wherein each group corresponds to a failure of the component.

3. The method of claim 2, wherein for each component, a sub-group includes one or more possible new conditions of the equipment after one of the repair or replacement of the first component.

4. The method of claim 1, wherein the work scope includes one or more operations performed on at least a second component of the equipment when the first component is one of being repaired and replaced.

5. The method of claim 1, wherein the recursion stop point is user-defined.

6. The method of claim 5, wherein the user-defined recursion stop point is a user-defined level of computation.

7. The method of claim 1, further comprising:
calculating a probability of failure for each component of the piece of equipment independently and in parallel.

8. The methods of claim 7, wherein calculating the probability further comprises:
modeling the failure probability with Weibull distributions.

9. The method of claim 7, further comprising:
calculating a life-cycle cost of replacing or repairing each component for each path from the group to the last sub-group generated at the recursion stop point, wherein each calculation is performed independently and in parallel;
and
determining an optimum work scope based on the calculated life-cycle cost.

10. The method of claim 9, wherein the optimum work scope is a cost function.

11. The method of claim 1, wherein the group is one of a condition cost and a time cost.

12. The method of claim 1, wherein the recursive generation of additional sub-groups is performed on one of a single thread and on a single node in a cloud.

13. The method of claim 9, wherein each of the calculations is stored in one or more files using one or more keys.

14. The method of claim 13, wherein the one or more keys store information about a position of each group, first level sub-group and second-level sub-group in each path.

15. A system comprising:
at least one piece of equipment including a plurality of components;
a structure module operative to:
receive data elements associated with optimizing a work scope to repair a first component of the plurality of components of the piece of equipment;
assign each component to a group;
create at least one sub-group for each group, wherein each sub-group is a first level sub-group; and
recursively generate at least one additional sub-group for each sub-group until a recursion stop point is achieved, wherein each additional sub-group is a second level sub-group, and without calculating a life-cycle cost for a path from the group to a last sub-group generated at the recursion stop point.

16. The system of claim 15, further comprising:
an optimization module operative to:
calculate a probability of failure for each component of the piece of equipment independently and in parallel;
calculate a cost of replacing or repairing each component for each path from the group to the last sub-group generated at the recursion stop point, wherein each calculation is performed independently and in parallel;
and
determine an optimum work scope based on the calculated life-cycle cost.

17. The system of claim 15, wherein each group corresponds to a failure of the first component.

18. The system of claim 17, wherein for each component, a sub-group includes one or more possible new conditions of the equipment after one of the repair and replacement of the first component.

19. The system of claim 15, wherein the work scope includes operations performed on at least a second component of the equipment when the first component is being one of repaired and replaced.

20. The system of claim 15, wherein the recursion stop point is user-defined.
